(19) United States
(12) Patent Application Publication
(10) Pub. No.: US 2014/0143528 A1
(43) Pub. Date: May 22, 2014

(54) Information Processing Apparatus and Control Method

(71) Applicant: Kabushiki Kaisha Toshiba, Tokyo (JP)

(72) Inventor: Tomonori Tsutsui, Ome-shi (JP)

(73) Assignee: KABUSHIKI KAISHA TOSHIBA, Tokyo (JP)

(21) Appl. No.: 13/947,965

(22) Filed: Jul. 22, 2013

(30) Foreign Application Priority Data
Nov. 19, 2012 (JP) 2012-253037

(51) Int. Cl. G06F 1/24; G06F 1/26

(52) U.S. Cl. CPC G06F 1/24; G06F 1/26
USPC 713/1

(57) ABSTRACT

According to one embodiment, an information processing apparatus includes a main body includes a battery, a display unit, a button switch, a sensor, a power management controller, a power supply circuit, and a power supply controller. The button switch is assigned with a first function. The sensor senses a closed state of the display unit. The power supply circuit supplies operation power to respective components in the information processing apparatus using power supplied from the battery. The power supply controller transmits a reset signal to the power management controller to cause the power management controller to execute initialization processing, if the button switch is pressed and the sensor senses the closed state of the display unit.

### CROSS-REFERENCE TO RELATED APPLICATIONS

This application is based upon and claims the benefit of priority from Japanese Patent Application No. 2012-253037, filed Nov. 19, 2012, the entire contents of which are incorporated herein by reference.

### FIELD

Embodiments described herein relate generally to an information processing apparatus which can be driven by a battery, and a control method applied to the apparatus.

### BACKGROUND

In recent years, various information processing apparatuses such as a tablet computer and notebook type personal computer (PC) have been developed. Many information processing apparatuses of this type include a battery, and can be driven using power supplied from the battery.

An information processing apparatus incorporating, within its main body, a battery has also been developed. As compared with the structure of a general information processing apparatus from which a battery is detachable, the structure in which the battery is incorporated in the main body can readily decrease the size of the apparatus and reduce the thickness of the apparatus.

In an information processing apparatus, in general, if the operation of the information processing apparatus fails due to a software failure such as freezing of an operating system, the user can forcibly power off the information processing apparatus by long-pressing a power switch.

If, however, the operation fails due to a failure of a controller for power management or the like, the controller cannot normally operate, and the user cannot forcibly power off the information processing apparatus even if he/she long-presses the power switch.

In the general information processing apparatus from which the battery is detachable, the above-described controller or the like of the apparatus can be reset by detaching an AC adapter or the battery to forcibly cut off power supplied to the information processing apparatus.

If the battery is incorporated in the main body of the information processing apparatus, it is not easy for the user to detach the battery.

Therefore, it is required to deal with, without detaching the battery, an operation failure which normally calls for detachment of the battery. At this time, it is also required to prevent an erroneous operation by the user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an information processing apparatus according to the first embodiment;

FIG. 2 is an exemplary block diagram showing the system configuration of the information processing apparatus according to the first embodiment;

FIG. 3 is an exemplary block diagram showing a configuration for forcibly terminating the information processing apparatus according to the first embodiment;

FIG. 4 is an exemplary flowchart illustrating a forcible termination processing procedure executed by the information processing apparatus according to the first embodiment;

FIG. 5 is an exemplary view showing a state in which a pressing member is attached to the display unit of the information processing apparatus according to the first embodiment so that the flat rear surface of the pressing member is exposed;

FIG. 6 is an exemplary view showing a state in which a pressing member is attached to the display unit of the information processing apparatus according to the first embodiment so that the front surface, including a projection, of the pressing member is exposed;

FIG. 7 is an exemplary view showing a state in which the pressing member attached to the display unit of the information processing apparatus according to the first embodiment has been rotated to a position where the flat rear surface is exposed;

FIG. 8 is an exemplary view showing a state in which the pressing member attached to the display unit of the information processing apparatus according to the first embodiment has been rotated to a position where the front surface including the projection is exposed;

FIG. 9 is an exemplary timing chart showing a forcible termination operation by the information processing apparatus according to the first embodiment;

FIG. 10 is an exemplary perspective view showing the outer appearance of an information processing apparatus according to the second embodiment;

FIG. 11 is an exemplary block diagram showing a configuration for forcibly terminating the information processing apparatus according to the second embodiment; and

FIG. 12 is an exemplary block diagram showing another configuration for forcibly terminating the information processing apparatus according to the second embodiment.

### DETAILED DESCRIPTION

Various embodiments will be described hereinafter with reference to the accompanying drawings.

In general, according to one embodiment, an information processing apparatus includes a main body comprising a battery, a display unit, a button switch, a sensor, a power management controller, a power supply circuit, and a power supply controller. The display unit is attached rotatably to the main body. The button switch is assigned with a first function. The sensor senses a closed state of the display unit. The power management controller performs power management of the information processing apparatus. The power supply circuit supplies operation power to respective components in the information processing apparatus using power supplied from the battery. The power supply controller is coupled to the button switch and the sensor, and transmits a reset signal to the power management controller to cause the power management controller to execute initialization processing, if the button switch is pressed and the sensor senses the closed state of the display unit.

### First Embodiment

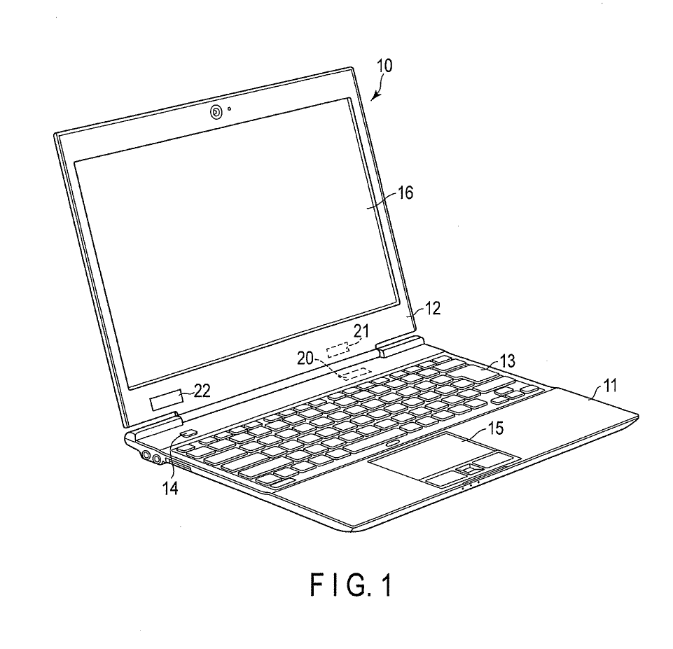

The configuration of an information processing apparatus according to the first embodiment will be described with reference to FIG. 1. The information processing apparatus is implemented as, for example, a portable personal computer 10 of notebook type which can be driven by a battery. FIG. 1 is a perspective view when viewed from the front side of the computer 10 with a display unit open. The computer 10 includes a main body (computer main body) 11 and a display unit 12. The display unit 12 incorporates a display device formed by an LCD (liquid crystal display) 16.

The display unit 12 is attached to the computer main body 11 rotatable between an open position where the upper surface of the computer main body 11 is exposed and a closed position where the upper surface of the computer main body 11 is covered with the display unit 12.

The computer main body 11 includes a thin box-like housing. A keyboard 13, a power button switch 14 for turning on/off the computer 10, and a pointing device 15 are arranged on the upper surface of the housing.

Furthermore, an opening/closing sensor (panel opening/closing sensor) 20 is arranged in the computer main body 11. The opening/closing sensor 20 is used to sense whether the display unit 12 is in an open state or closed state. The opening/closing sensor 20 can sense the closed state of the display unit 12. The opening/closing sensor 20 can also sense that the display unit 12 is open. The opening/closing sensor 20 may be a magnetic sensor (Hall element). A magnetic material (magnet) 21 is arranged on the front surface of the display unit 12. The opening/closing sensor (magnetic sensor) 20 can sense whether the magnetic material 21 is close to the opening/closing sensor 20, that is, whether the display unit 12 is the closed state.

The computer main body 11 incorporates a battery. The computer 10 can operate using power from the battery. This battery is implemented by a built-in (internal) battery pack. In general, therefore, the user cannot detach the battery from the computer main body 11.

The computer main body 11 includes a power management controller for powering on/off the computer 10 in response to press of the power button switch 14. As described above, if an erroneous operation of the power management controller occurs, the user cannot forcibly power off the computer 10 even if he/she long-presses the power button switch 14.

If an unexpected erroneous operation of the power management controller occurs, it is possible to reset the power management controller by detaching both the AC adapter and the battery from the computer main body 11. If, however, the battery is a built-in battery pack, it cannot be readily detached. In this case, it is impossible to use the above-described method of resetting the power management controller by detaching both the AC adaptor and the battery from the computer main body 11.

In this embodiment, if the power button switch 14 is pressed and the opening/closing sensor 20 senses the closed state of the display unit 12, that is, if a condition “power button switch pressing state+display unit closed state” is satisfied, an operation of resetting the power management controller is executed. Using the condition “power button switch pressing state+display unit closed state” enables to readily deal with the operation failure of the computer 10 even if button switches other than the power button switch 14 are not provided in the computer main body 11.

If the power button switch 14 is provided on a side surface of the computer main body 11, the user can perform an operation for satisfying the condition “power button switch pressing state+display unit closed state” by only closing the display unit 12 while pressing the power button switch 14.

If the power button switch 14 is arranged on the upper surface of the computer main body 11, as shown in FIG. 1, it is difficult for the user to close the display unit 12 while pressing the power button switch 14. However, the user can perform an operation for satisfying the condition “power button switch pressing state+display unit closed state” by, for example, moving a magnet in a hand close to the upper surface of the computer main body 11 while pressing the power button switch 14.

Alternatively, the display unit 12 may include a pressing member 22 settable at a first position where the pressing member 22 protrudes from the front surface of the display unit 12 or a second position where the pressing member 22 is accommodated in the display unit 12.

The pressing member 22 is a member for pressing the power button switch 14 when the display unit 12 is closed. If the display unit 12 is closed with the pressing member 22 arranged at the first position (protrusion position), the pressing member 22 presses the power button switch 14. This can satisfy the condition “power button switch pressing state+display unit closed state”.

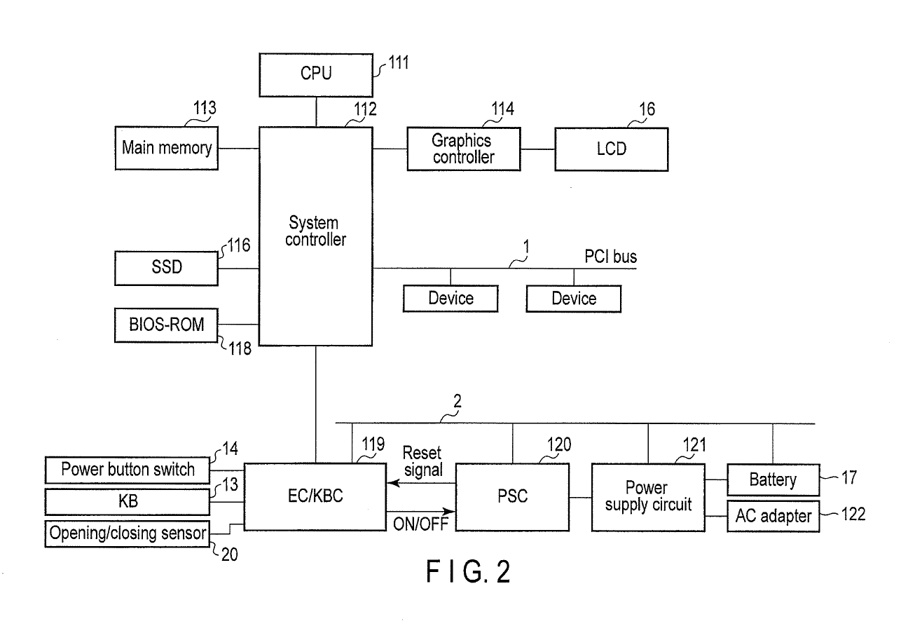

FIG. 2 shows the system configuration of the computer 10. The computer 10 includes a CPU 111, a system controller 112, a main memory 113, a graphics controller (GPU) 114, a solid state drive (SSD) 116, a BIOS-ROM 118, an embedded controller/keyboard controller (EC/KBC) 119, a power supply controller (PSC) 120, a power supply circuit 121, a battery 17, and the like.

The CPU 111 is a processor configured to control the operation of each component of the computer 10. The CPU 111 executes various kinds of software programs loaded from the SSD 116 into the main memory 113, for example, an operating system (OS) and various application programs. The CPU 111 also executes the BIOS (Basic Input Output System) stored in the BIOS-ROM 118 as a non-volatile memory. The BIOS is a system program for hardware control.

The system controller 112 is a bridge device for connecting the CPU 111 with each component. The system controller 112 incorporates a serial ATA controller for controlling the SSD 116. Furthermore, the system controller 112 also has a function of communicating with the GPU 114 via a serial bus complying with, for example, the PCI EXPRESS standard.

The GPU 114 is a display controller which controls the LCD 16 used as a display monitor of the computer 10. The GPU 114 generates a display signal to be supplied to the LCD 16, from display data stored in a video memory. Part of the main memory 113 may be used as the above-described video memory.

The EC/KBC 119, power supply controller (PSC) 120, power supply circuit 121, and battery 17 are connected to each other through a serial bus 2 such as an I2C bus. The EC/KBC 119 is a one-chip microcomputer incorporating an embedded controller (power management controller) for power management of the computer 10, and a keyboard controller for controlling the keyboard (KB) 13 and the pointing device 15. The EC/KBC 119 has a function of powering on/off the computer 10 according to a user operation.

The EC/KBC 119 has a function of powering on/off the computer 10 according to an operation of the power button switch 14 carried out by the user. The power on/off control of the computer 10 is executed by the cooperation of the EC/KBC 119 and power supply controller (PSC) 120. According to an ON/OFF signal transmitted by the embedded controller of the EC/KBC 119, the power supply controller (PSC) 120 controls the power supply circuit 121 to power on or off the computer 10. Upon receiving an ON signal transmitted by the embedded controller of the EC/KBC 119, the power supply controller (PSC) 120 sets, to “high” level, a power-on signal to be sent to the power supply circuit 121, and causes the power supply circuit 121 to power on the computer 10. Upon receiving an OFF signal transmitted by the embedded controller of the EC/KBC 119, the power supply controller (PSC) 120 sets, to “low” level, a power-on signal to be sent to the power supply circuit 121, and causes the power supply circuit 121 to power off the computer 10. Even while the computer 10 is OFF, the EC/KBC 119, the power supply controller (PSC) 120, and the power supply circuit 121 operate by power from the battery 17 or power from an AC adapter 122.

The power supply circuit 121 generates operation power to be supplied to each component using power from the battery 17 or power from the AC adapter 122 connected to the computer main body 11 as an external power supply. If the AC adapter 122 is connected to the computer main body 11, the power supply circuit 121 can generate operation power to be supplied to each component using power from the AC adapter 122, and also charge the battery 17.

The battery 17 is the above-described built-in battery, and is incorporated in the computer main body 11. If an unexpected erroneous operation of the EC/KBC 119 of the computer 10 occurs, it is normally possible to reset the EC/KBC 119 by detaching both the AC adapter 122 and the battery 17, as described above. Since, however, the battery 17 is an internal battery which is not detachable, it is impossible to use a method of forcibly terminating the computer 10 by detaching the battery.

In the first embodiment, the power supply controller (PSC) 120 monitors the state of the power button switch 14 and state of the opening/closing sensor 20. If the power button switch 14 is pressed and the opening/closing sensor 20 senses the closed state of the display unit 12, that is, the condition “power button switch pressing state+display unit closed state” is satisfied, the power supply controller (PSC) 120 transmits a reset signal to the EC/KBC 119 to causes the EC/KBC 119 to execute initialization processing. Thus, it is possible to forcibly terminate the computer 10, and return the computer 10 to a normal state.

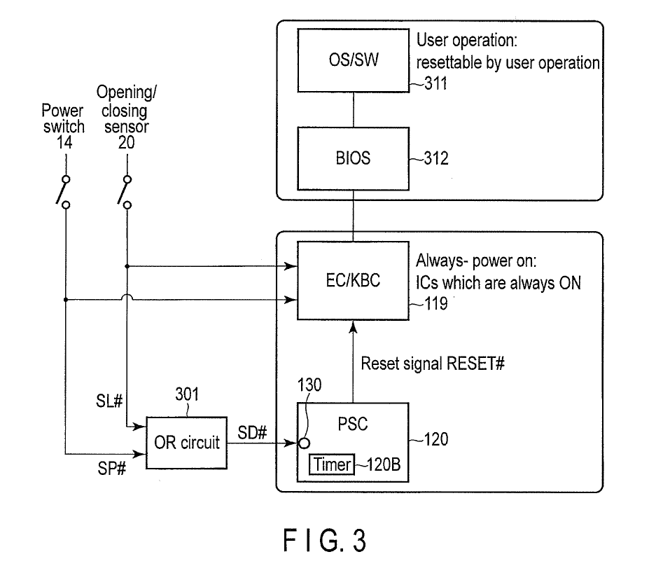

The configuration in which the computer 10 is forcibly terminated by sensing that the power button switch 14 is pressed and the display unit 12 is in the closed state (“power button switch pressing state+display unit closed state”) will be described with reference to FIG. 3.

An output signal of the power button switch 14 and an output signal of the opening/closing sensor 20 are supplied to not only the EC/KBC 119 but also the two inputs of a two-input OR circuit 301. The OR circuit 301 is a circuit (logical circuit) for detecting a state in which the power button switch 14 is pressed and the opening/closing sensor 20 detects the closed state of the display unit 12. The OR circuit 301 outputs a detection signal SD# to the PSC 120 according to an output signal SP# of the power button switch 14 and an output signal SL# of the opening/closing sensor 20. Note that the circuit shown in FIG. 3 is a low-active circuit. While the power button switch 14 is pressed, the output signal SP# at “low” level is input to the OR circuit 301. While the power button switch 14 is not pressed, the output signal SP# at “high” level is input to the OR circuit 301. While the opening/closing sensor 20 detects the closed state of the display unit 12, the output signal SL# at “low” level is input to the OR circuit 301. While the opening/closing sensor 20 detects the open state of the display unit 12, the output signal SL# at “high” level is input to the OR circuit 301. While the condition “power button switch pressing state+display unit closed state” is satisfied, the OR circuit 301 outputs the detection signal SD# at “low” level. The detection signal SD# is supplied to the PSC 120. Note that a symbol “#” added to each signal shown in FIG. 3 indicates that the signal is low-active. The detection signal SD# of the OR circuit 301 is assigned to an interrupt port 130 of the PSC 120. In response to the occurrence of an event “power button switch pressing state+display unit closed state”, the PSC 120 can start interrupt processing, and execute processing for resetting the EC/KBC 119 in the interrupt processing. The PSC 120 can process the event “power button switch pressing state+display unit closed state” as an event having high priority.

If the OR circuit 301 outputs the detection signal SD# at “low” level, the PSC 120 operates a timer 120B for determining whether a time (to be referred to as a simultaneous detection time hereinafter) during which the condition “power button switch pressing state+display unit closed state” is satisfied exceeds a reference time. The timer 120B is, for example, a down counter. The reference time of the timer 120B is, for example, 10 sec. When the detection signal SD# is set to “high” level, the timer 120B terminates time measurement. If the reference time elapses after the timer 120B starts, that is, if the value of the timer 120B becomes 0, the PSC 120 temporarily stops internal clock of the PSC 120. The PSC 120 is then reset. If the PSC 120 is reset, a power-on signal sent from the PSC 120 to the power supply circuit 121 is set to “low” level. If the power-on signal is set to “low” level, the power supply circuit 121 stops supplying operation power to the respective components except for the PSC 120 and EC/KBC 119. After restart of the internal clock of the PSC 120, the PSC 120 restarts the operation. In this case, a program counter returns to the same memory address as that in a hardware reset operation, and the PSC 120 starts an initialization sequence. Upon start of the initialization sequence, the PSC 120 sets, to “valid”, the reset signal to be sent to the EC/KBC 119.

Upon completion of the initialization sequence of the PSC 120, the PSC 120 sets, to “invalid”, the reset signal to be sent to the EC/KBC 119. The EC/KBC 119 executes an initialization sequence.

If the EC/KBC 119 normally operates without any unexpected erroneous operation, the EC/KBC 119 can instruct the PSC 120 to power off the computer, according to an instruction from an operating system/software (OS/SW) 311 via a BIOS 312.

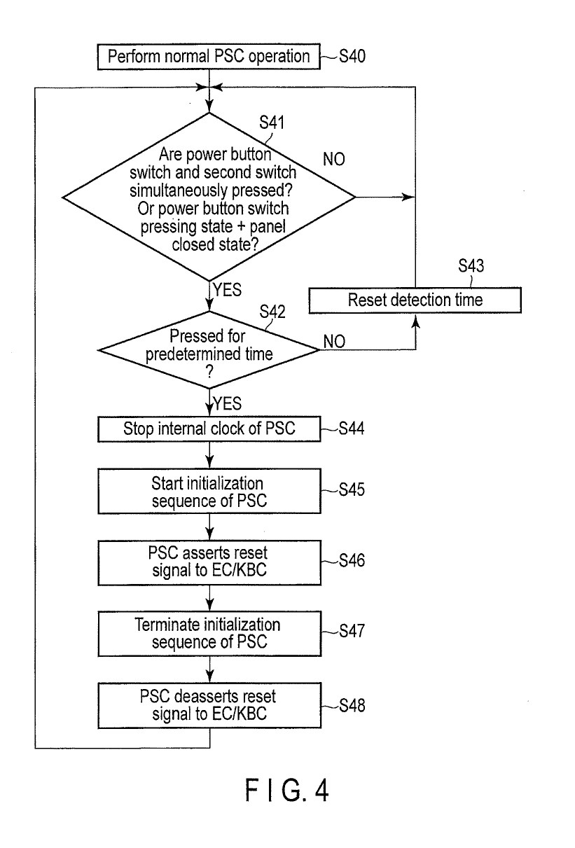

A forcible termination processing procedure which is executed by the computer 10 when the condition “power button switch pressing state+display unit closed state” is satisfied will be described with reference to a flowchart shown in FIG. 4.

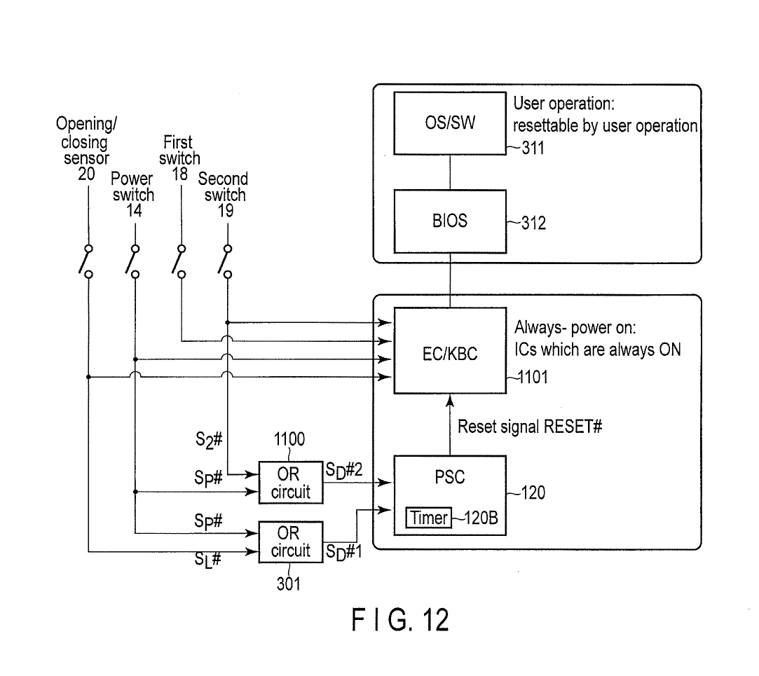

Based on the detection signal SD# output from the OR circuit 301, the PSC 120 periodically determines whether the condition “power button switch pressing state+display unit closed state” is satisfied, or whether the power button switch 14 and a second switch have been simultaneously operated (step S41). Note that the simultaneous operations of the power button switch 14 and the second switch will be described later with reference to FIG. 12. If it is determined that the condition “power button switch pressing state+display unit closed state” is satisfied (YES in step S41), the PSC 120 operates the timer 120B for determining whether the above-described simultaneous detection time has exceeded the reference time.

If the condition “power button switch pressing state+display unit closed state” is no longer satisfied, and the detection signal SD# output from the OR circuit 301 is set to “low” level (NO in step S41), the timer 120B terminates time measurement, and the timer 120B is reset (step S43). Note that if the condition “power button switch pressing state+display unit closed state” is satisfied again, the PSC 120 starts the timer 120B again. If the value of the timer 120B becomes 0 (YES in step S41), the PSC 120 stops the internal clock of the PSC 120 (step S44). The PSC 120 starts initialization sequence of the PSC 120 (step S45). A power-on signal to be output from the PSC 120 to the power supply circuit 121 is set to “low” level. The power supply circuit 121 stops supplying operation power to the components other than the PSC 120 and EC/KBC 119. The PSC 120 asserts a reset signal RESET# to the EC/KBC 119 (sets the reset signal RESET# to an active state) (step S46). While the reset signal RESET# is asserted, the EC/KBC 119 is maintained in an operation stop state (reset state). Note that upon start of the initialization sequence of the PSC 120, the PSC 120 may set the reset signal RESET# to the active state. The initialization sequence of the PSC 120 then ends (step S47). The PSC 120 deasserts the reset signal RESET# (sets the reset signal RESET# to an inactive state) (step S48). Note that upon completion of the initialization sequence of the PSC 120, the PSC 120 may set the reset signal RESET# to the inactive state. When the reset signal RESET# is deasserted, the reset state of the EC/KBC 119 is canceled, and the EC/KBC 119 starts the initialization sequence (initialization processing). Upon completion of the initialization sequence of the EC/KBC 119, it becomes possible to power on the computer 10 by operating the power button switch 14.

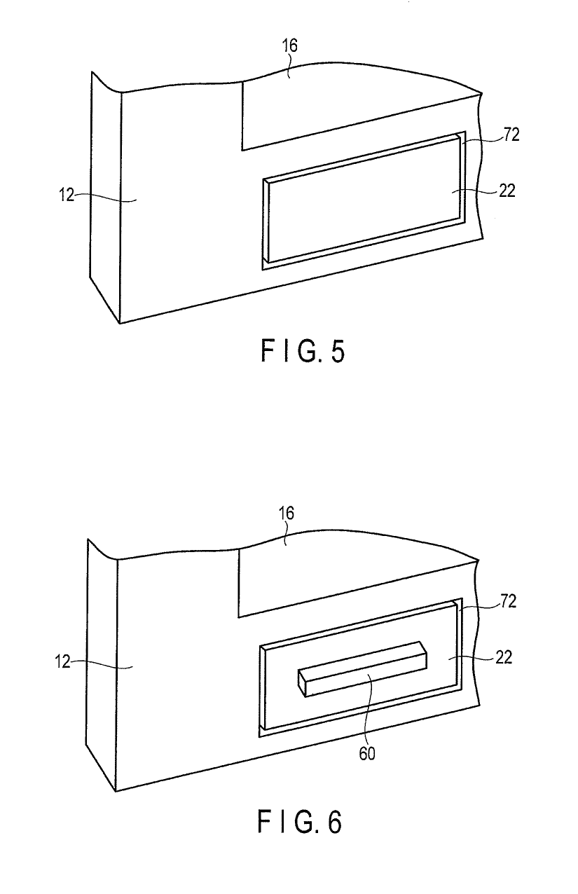

Details of the pressing member 22 will be exemplified with reference to FIGS. 5 and 6.

FIG. 5 shows part of the display unit 12 including the pressing member 22. The pressing member 22 is proveded in the display unit 12 so as to be settable at a position (first position) where the pressing member 22 protrudes from the front surface of the display unit 12 or a position (second position) where the pressing member 22 is accommodated in the display unit 12. If the display unit 12 is closed with the pressing member 22 set at the first position, the pressing member 22 presses the power button switch 14.

As shown in FIGS. 5 and 6, the pressing member 22 has a front surface including a projection and a flat rear surface, and is detachably attached to a recess 72 of the front surface of the display unit 12. FIG. 5 shows a state in which the pressing member 22 is attached to the display unit 12 so that the rear surface of the pressing member 22 is exposed.

FIG. 6 shows a state in which the pressing member 22 is attached to the display unit 12 so that the front surface of the pressing member 22 is exposed. The front surface of the pressing member 22 includes a projection 60. The pressing member 22 is accommodated in the display unit 12 while the projection 60 protrudes from the front surface of the display unit 12. While the display unit 12 is closed, therefore, the projection 60 can press the power button switch 14.

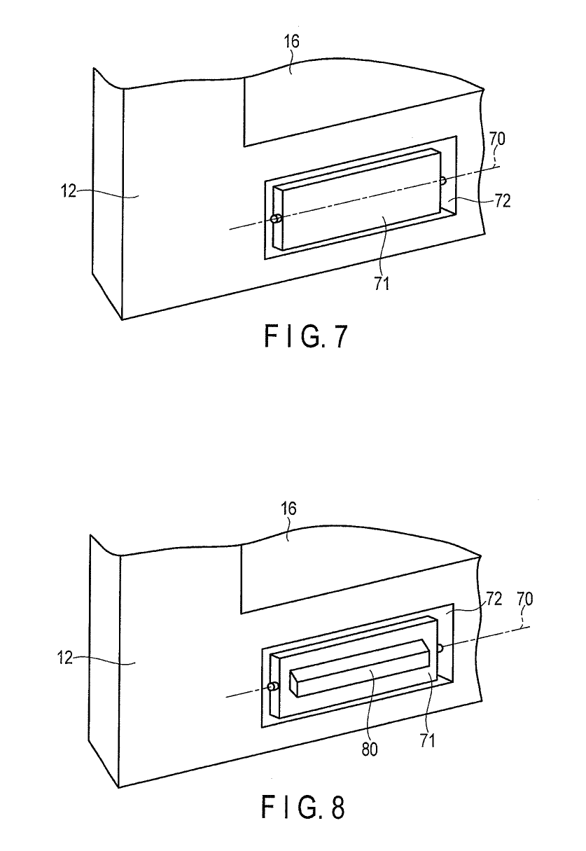

Another example of the pressing member 22 will be described with reference to FIGS. 7 and 8.

A case in which the pressing member 22 is detachable from (attachable to) the display unit 12 has been described with reference to FIGS. 5 and 6. FIGS. 7 and 8 assume that the pressing member 22 has a front surface including a projection and a flat rear surface, and the pressing member 22 is attached to the recess 72 of the front surface of the display unit 12 rotatable between the position (first position) where the front surface of the pressing member is exposed and the position (second position) where the rear surface is exposed.

A pressing member 71 is rotatable about an axis 70. FIG. 7 shows a state in which the pressing member 71 has been rotated and the rear surface of the pressing member 71 is exposed on the front surface side of the display unit 12.

FIG. 8 shows a state in which the pressing member 71 has been rotated and the front surface of the pressing member 71 is exposed on the front surface side of the display unit 12. The front surface of the pressing member 71 includes a projection 80.

As shown in FIGS. 7 and 8, since the pressing member 71 is rotatable, for example, it is possible to set the pressing member 71 at the position (the first position) where the projection 80 protrudes from the front surface of the display unit 12 without detaching the pressing member 71 from the display unit 12.

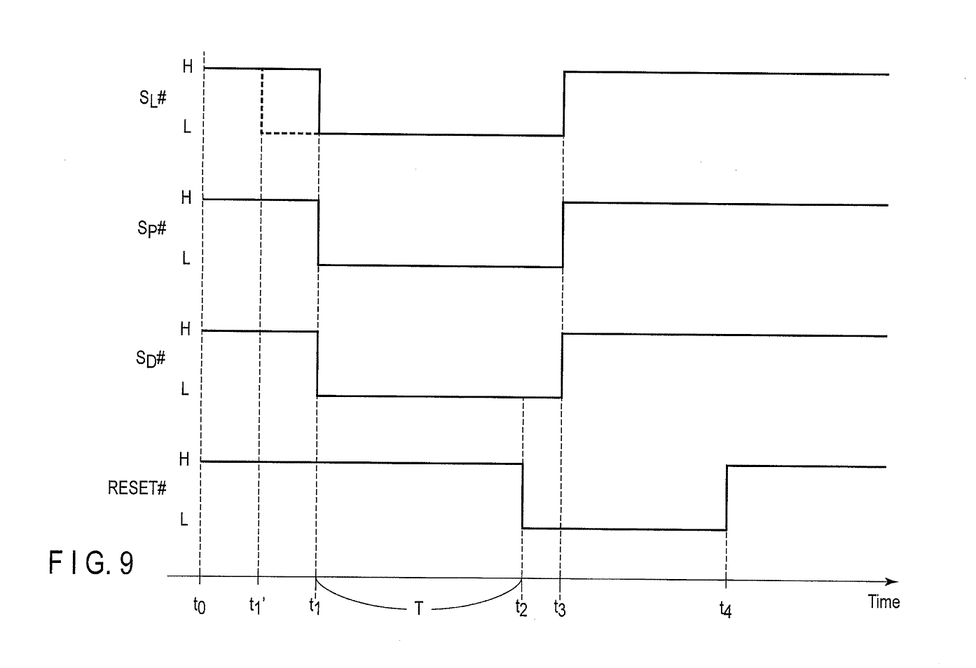

The timings of the respective signals described with reference to FIG. 3 will be explained with reference to FIG. 9.

At a time to, a normal PSC operation in step S40 shown in FIG. 4 is performed. A normal PSC operation state indicates a state in which the condition “power button switch pressing state+display unit closed state” is not satisfied. At the time t0, the output signal SL#, output signal SP#, detection signal SD#, and reset signal RESET# are respectively at “high (H)” level.

At a time t1, the condition “power button switch pressing state+display unit closed state” is satisfied for the first time. At the time t1, the signal SL# and the signal SP# is set to “low (L)” level, and thus the detection signal SD# is also set to “low (L)” level.

Before the power button switch 14 is pressed, the opening/closing sensor 20 may sense the closed state of the display unit 12. A time t1′ indicates a time when the opening/closing sensor 20 senses the closed state of the display unit 12. The signal SL# is set to “low (L)” level at the time t1′. Since, however, the signal SP# is at “high (H)” level, the detection signal SD# remains at “high (H)” level. Note that if the signal SP# is set to “low (L)” level at the time t1 after the signal SL# is set to “low (L)” level at the time t1′, the detection signal SD# is set to “high (H)” level at the time t1.

A time t2 indicates a time elapsed a reference time T after the time t1. The reference time T is a time from when the detection signal SD# is set to “low (L)” level until the PSC 120 starts processing of resetting the EC/KBC 119, for example, 10 sec, as described above. Note that if a state in which the power button switch 14 is in the pressing state for the reference time T or longer and the display unit 12 is in the closed state lasts for the reference time T or longer, the PSC 120 need only reset the EC/KBC 119 by transmitting the reset signal RESET# to the EC/KBC 119. Therefore, it is not necessary to reset the EC/KBC 119 immediately after the reference time T elapses after the time t1. More specifically, after the reference time T elapses after the time t1, and then, for example, a time necessary for stopping the internal clock of the PSC 120 elapses, the EC/KBC 119 may be reset.

A time t3 indicates a time that the power button switch 14 ceases to be pressed or the opening/closing sensor 20 ceases to sense the closed state of the display unit 12, after the initialization sequence of the PSC 120 starts. After the initialization sequence of the PSC 120 starts, the reset signal RESET# continues to be at “low (L)” level even if the condition “power button switch pressing state+display unit closed state” is not satisfied.

At a time t4, the initialization sequence of the PSC 120 ends. Upon completion of the initialization sequence of the PSC 120, the reset signal RESET# is set to “high (H)” level, and transmission of the reset signal RESET# stops.

Note that the EC/KBC 119 can execute an operation for powering off the computer 10, for example, a forcible termination operation. The forcible termination operation can be performed by long-pressing the power button switch 14 for a predetermined period (first period), for example, 4 sec. If, therefore, a state in which the power button switch 14 is in the pressing state and the display unit 12 is in the closed state lasts for a period (second period) longer than the first period, for example, 10 sec, the PSC 120 resets the EC/KBC 119 by transmitting the reset signal RESET# to the EC/KBC 119. If the second period is equal to or shorter than the first period, the EC/KBC 119 may be unwantedly reset when the condition “power button switch pressing state+display unit closed state” is satisfied, even though the EC/KBC 119 normally operates. In this embodiment, since the second period is set to be sufficiently longer than the first period, the above-described problem can be prevented.

As described above, according to the first embodiment, if an unexpected erroneous operation of the EC/KBC 119 occurs in the computer 10 including the power button switch 14, it is possible to forcibly terminate the computer 10 under the condition “power button switch pressing state+display unit closed state”, and it is also possible to reset the EC/KBC 119 and PSC 120. Furthermore, initializing the PSC 120 before starting the initialization sequence of the EC/KBC 119 allows initialization of the EC/KBC 119 while the PSC 120 is stable. Since the PSC 120 monitors that the power button switch 14 is pressed and the display unit 12 is closed, an erroneous operation by the user can be prevented.

Note that if the computer 10 includes button switches other than the power button switch 14, the computer 10 may be forcibly terminated under the condition “another button switch pressing state+display unit closed state”.

### Second Embodiment

A description of the same configurations and functions as those in the first embodiment will be omitted.

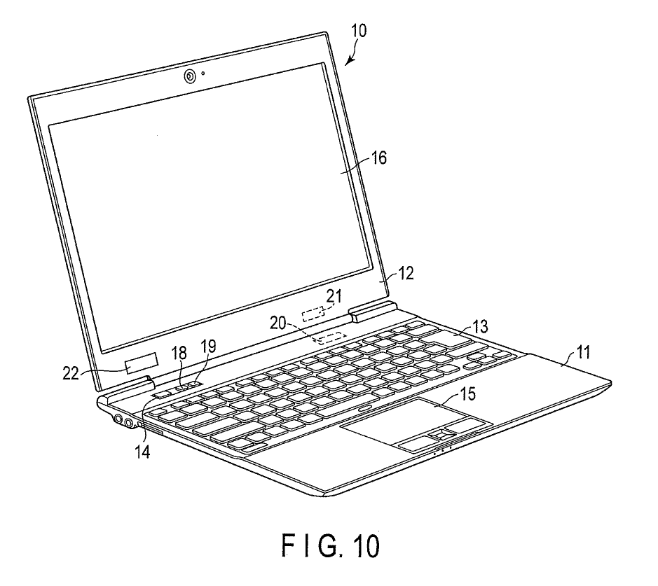

FIG. 10 shows the configuration of the computer 10 according to the second embodiment. In the second embodiment, if “predetermined button switch pressing state+display unit closed state” is sensed, the computer 10 is forcibly terminated. The predetermined button switch is, for example, the power button switch 14, a first button switch 18, a second button switch 19, or the like arranged on the upper surface of the computer main body 11, as shown in FIG. 10. In the second embodiment, in addition to the power button switch 14, a plurality of button switches such as the first button switch 18 and the second button switch 19 are arranged on the upper surface of the computer main body 11.

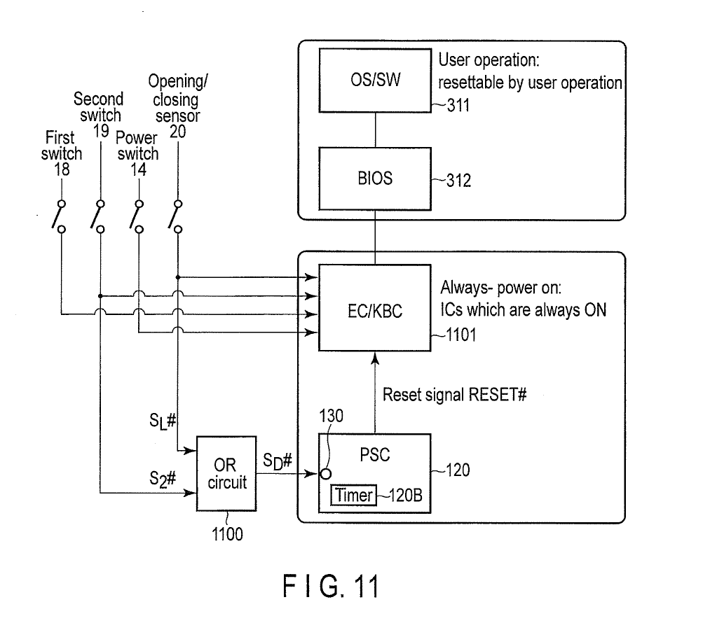

A practical configuration according to the second embodiment will be described with reference to FIG. 11.

Referring to FIG. 11, an OR circuit 1100 is connected with the opening/closing sensor 20 and the second button switch 19. If an output signal SL# is at “low” level and an output signal S2# of the second button switch is at “low” level, the OR circuit 1100 outputs a detection signal SD# to the PSC 120.

Note that a function of causing the computer to execute predetermined processing is assigned to the first button switch 18 and second button switch 19. For example, a function (first function) of causing the computer to execute, according to a predetermined operation, an application program assigned to the first button switch 18 or second button switch 19 is assigned to the first button switch 18 or second button switch 19.

An EC/KBC 1101 is connected with the opening/closing sensor 20, power button switch 14, first button switch 18, and second button switch 19. The EC/KBC 1101 performs processing for executing a function such as the first function based on a signal supplied by the opening/closing sensor 20, power button switch 14, first button switch, or second button switch.

As described above, according to the second embodiment, if the predetermined button switch is pressed unlike the power button switch 14 is pressed and the opening/closing sensor 20 senses a closed state of the display unit 12, the PSC 120 can cause the EC/KBC 1101 to execute initialization processing by transmitting a reset signal to the EC/KBC 1101.

Another configuration example according to the second embodiment will be described.

If a condition “power button switch pressing state+display unit closed state” or a condition “power button switch pressing state+second button switch pressing state” is satisfied, the EC/KBC 1101 executes initialization processing. If the power button switch 14 and the second button switch 19 are simultaneously pressed, the condition “power button switch pressing state+second button switch pressing state” is satisfied.

FIG. 12 shows the configuration of an information processing apparatus according to the other configuration example of the second embodiment. The computer 10 includes two OR circuits 301 and 1100. If an output signal SL# and an output signal S2# of the second button switch 19 are at “low” level, the OR circuit 301 sends a detection signal SD#1 to the PSC 120. If the output signal S2# and an output signal SP# of the power button switch 14 are at “low” level, the OR circuit 1100 sends a detection signal SD#2 to the PSC 120. If the detection signal SD#1 or SD#2 is at “low” level, the timer 120B starts time measurement.

Note that in the other configuration example of the second embodiment, forcible termination processing is executed when two button switches are simultaneously pressed. The forcible termination processing, however, may be executed when three or more button switches are simultaneously pressed. Alternatively, the forcible termination processing may be executed when three or more button switches are operated in a predetermined order. Although the power button switch 14 is included in the three or more button switches, three or more button switches may include a button switch other than the power button switch 14. Although the computer 10 includes the keyboard 13 and a keyboard controller, even a computer without the keyboard 13 or keyboard controller such as a slate-type computer may execute forcible termination processing by pressing two or more button switches.

As described above, according to the other configuration example of the second embodiment, if the computer 10 includes a plurality of button switches, it is possible to forcibly terminate the computer 10 and it is also possible to reset the EC/KBC 1101 and PSC 120, when the condition “power button switch pressing state second button switch pressing state” is satisfied. Unlike the first button switch 18 adjacent to the power button switch 14, the second button switch 19 which is not adjacent to the power button switch 14, and the power button switch 14 are pressed at the same time. This enables to suppress a problem that the initialization sequence of the EC/KBC 1101 starts due to, for example, an erroneous pressing operation by the user.

As described above, according to the first and second embodiments, even if the EC/KBC 119 does not normally operate and it is thus impossible to power off the information processing apparatus from which the battery 17 is not detachable, the PSC 120 monitors the state of a predetermined button switch such as the power button switch 14 and the opening/closing state of the display unit 12. It is, therefore, possible to obtain the same effects as those obtained by executing reset processing for the EC/KBC 119 or PSC 120 when the battery 17 is detached. Including the pressing member 22 makes it possible to press the power button switch 14 simultaneously with closing of the display unit 12. Furthermore, by assigning the detection signal SD# to the interrupt port, the above-described reset processing can be preferentially performed.

Note that the opening/closing sensor 20 may be a sensor other than a magnetic sensor. The sensor other than a magnetic sensor, for example, is a sensor which senses the closed state of the display unit 12 when the computer main body 11 touches the display unit 12.

The button switch such as the power button switch 14 or first button switch 18 may be a switch which is not a button type, for example, a sensor type switch.

Moreover, by performing an operation for satisfying the condition “power button switch pressing state+display unit closed state”, the EC/KBC 119 may only be initialized without stopping the function of the EC/KBC 119. This enables to initialize the embedded controller serving as the power management controller within the EC/KBC 119. By long-pressing the power button switch 14 after initializing the embedded controller, the computer 10 can be forcibly terminated, thereby resetting the EC/KBC 119.

Note that the EC/KBC 119 is a microcomputer including the EC and KBC, and thus may hang up. However, the PSC 120 has a structure simpler than a structure of the EC/KBC 119, and an erroneous operation of the PSC 120 occurs at an extremely low probability. It is, therefore, possible to execute the above-described reset processing when the PSC 120 monitors whether the power button switch 14 and the second switch are simultaneously operated.

As described above, the opening/closing sensor 20 senses the closed state of the display unit 12, when the magnetic material 21 is close to the opening/closing sensor 20. By moving a magnetic material other than the magnetic material 21 included in the display unit 12 close to the opening/closing sensor 20, the opening/closing sensor 20 can sense the closed state of the display unit 12 even though the display unit 12 is not closed. Therefore, for example, when the user moves a magnetic material such as a magnet other than the magnetic material 21 close to the opening/closing sensor 20, and when the power button switch 14 is pressed, the condition “power button switch pressing state+display unit closed state” can be satisfied.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body comprising a battery;
a display unit attached rotatably to the main body;
a button switch assigned with a first function;
a sensor configured to sense a closed state of the display unit;
a power management controller configured to perform power management of the information processing apparatus;
a power supply circuit configured to supply operation power to respective components in the information processing apparatus using power supplied from the battery; and
a power supply controller coupled to the button switch and the sensor, and configured to transmit a reset signal to the power management controller to cause the power management controller to execute initialization processing, if the button switch is pressed and the sensor senses the closed state of the display unit.

2. The apparatus of claim 1, wherein the power supply controller is further configured to transmit the reset signal to the power management controller, if a state in which the button switch is in a pressing state and the display unit is in the closed state lasts for a period not shorter than a reference time.

3. The apparatus of claim 1, wherein the power management controller comprises a microcomputer, the microcomputer comprising an embedded controller configured to perform power management of the information processing apparatus and a keyboard controller configured to control a keyboard.

4. The apparatus of claim 1, wherein
the button switch is on an upper surface of the main body, and
the display unit comprises a pressing member settable at a first position where the pressing member protrudes from a front surface of the display unit or a second position where the pressing member is accommodated in the display unit, wherein the pressing member is configured to press the button switch when the display unit with the pressing member set at the first position is closed.

5. The apparatus of claim 4, wherein the pressing member comprises a front surface and a flat rear surface, the front surface comprising a projection, the pressing member being detachably attached to a recess of the front surface of the display unit.

6. The apparatus of claim 4, wherein the pressing member comprises a front surface and a flat rear surface, the front surface comprising a projection, the pressing member being attached to a recess of the front surface of the display unit rotatably between a position where the front surface of the pressing member is exposed and a position where the rear surface is exposed.

7. The apparatus of claim 1, wherein the sensor comprises a magnetic sensor.

8. The apparatus of claim 1, wherein the button switch comprises a power button switch.

9. The apparatus of claim 8,
wherein the power management controller is further configured to execute an operation for powering off the information processing apparatus when the power button switch is pressed for a first period, and
wherein the power supply controller is further configured to transmit the reset signal to the power management controller, if a state in which the power button switch is in a pressing state and the display unit is in the closed state lasts for a period longer than the first period.

10. A control method for an information processing apparatus, the information processing apparatus comprising a main body with a battery, a display unit attached rotatably to the main body, a power management controller configured to perform power management of the information processing apparatus, and a power supply circuit configured to supply operation power to respective components in the information processing apparatus using power supplied from the battery, the method comprising:
sensing, by a sensor, whether the display unit is in a closed state; and
transmitting a reset signal to the power management controller to cause the power management controller, to execute initialization processing, if a button switch assigned with a first function is pressed and the sensor senses the closed state of the display unit.
